(19) United States
(12) Patent Application Publication
(10) Pub. No.: US 2014/0371953 A1
(43) Pub. Date: Dec. 18, 2014

(54) BICYCLE SYSTEM UTILIZING WIRELESS TECHNOLOGY AND METHOD OF USING THE SAME

(71) Applicants: Craig M. Miller, Las Vegas, NV (US); Clayton E. Thomas, Las Vegas, NV (US)

(72) Inventors: Craig M. Miller, Las Vegas, NV (US); Clayton E. Thomas, Las Vegas, NV (US)

(21) Appl. No.: 14/308,618

(22) Filed: Jun. 18, 2014

Related U.S. Application Data
(60) Provisional application No. 61/836,341, filed on Jun. 18, 2013.

(51) Int. Cl. B60Q 1/00; B62M 9/12; B62K 23/00

(52) U.S. Cl. CPC B60Q 1/0076; B60Q 1/0094; B62K 23/00; B62M 9/12
USPC 701/2

(57) ABSTRACT

A bicycle with one or more brake lights, brake levers configured to activate integral pressure switches upon depression wherein said integral pressure switches are configured to trigger a BLE transmitter to send a BLE signal to one or more BLE receivers in communication with the one or more brake lights thereby actuating the same. The brake light can be mounted on the bicycle seat or seat post or can be integrated into a helmet design or retrofitted to an existing helmet. The bicycle system includes turn signals actuated using BLE signals. A mobile device may be incorporated into the system to utilize BLE signals to wirelessly control gear shifting of the bicycle responsive to a rider's physical condition (e.g., heart rate) in combination with bicycle conditions (e.g., crank torque) and environmental conditions (e.g., wind speed and direction).

### CROSS-REFERENCE

This application claims priority to U.S. Patent Application No. 61/836,341 filed Jun. 18, 2013 which is incorporated herein for any and all purposes.

### FIELD OF THE INVENTION

The embodiments of the present invention relate to a bicycle system incorporating wireless technology and/or smart phone technology (e.g., Bluetooth Low Energy (BLE)) allowing a rider to control certain bicycle functionality.

### BACKGROUND

Bicycling, along with many other outdoor activities, is becoming more and more popular. Bicycling however can be dangerous and tedious as it relates to certain functionalities associated therewith. The use of wireless technology and mobile device (e.g., smart phone) technology to interact with a bicycle results in improved safety and overall bicycle efficiency.

It would be useful and advantageous to integrate wireless and smart phone technologies into bicycles thereby improving safety and efficiency.

### SUMMARY

Accordingly, one embodiment of the present invention comprises a bicycle with one or more brake lights and brake levers configured to activate integral pressure switches upon depression wherein said integral pressure switches are configured to send a wireless (e.g., BLE) signal to one or more wireless (e.g., BLE) receivers in communication with said one or more brake lights thereby actuating the one or more brake lights. In one embodiment, the brake lights are light emitting diodes (LEDs). The brake lights can be mounted on the bicycle seat or seat post or can be integrated into a helmet design or retrofitted on an existing helmet.

In another embodiment, the bicycle system includes turn signals actuated using wireless signals. For example, a small rocker switch mounted on the handlebars or seat post is utilized by the rider to activate BLE-equipped LED turn signals in the handle bars. The same lights may also be configured to flash denoting an emergency sense or act as running lights.

Aftermarket kits can be made to retrofit existing bicycles, namely the brake levers and brakes, and with new bicycles the brake levers and brakes may be manufactured with the integral pressure switches and BLE receivers integrated therewith. In one embodiment, an iPhone® or other smart mobile device with BLE capability may be incorporated into the bicycle system such that a brake light module can report, for example, battery and bulb condition.

In another embodiment, the BLE system can activate a strobe and control brightness of headlights and tail lights.

In another embodiment, BLE inputs wirelessly control gear shifting of the bicycle. In another embodiment, a rider's physical condition (e.g., heart rate) in combination with bicycle conditions (e.g., crank torque) and environmental conditions (e.g., wind speed and direction) are used to automate gear shifting of the bicycle.

Other variations, embodiments and features of the present invention will become evident from the following detailed description, drawings and claims.

### BRIEF DESCRIPTION OF THE DRAWINGS

FIG. 1 illustrates a block diagram of a bicycle system according to the embodiments of the present invention;

FIG. 2 illustrates a block diagram system including smartphone technology according to the embodiments of the present invention;

FIG. 3 illustrates a block diagram detailing an automated gear shifting system of a bicycle according to the embodiments of the present invention;

FIG. 4 illustrates a flow chart of an automated gear shifting system of a bicycle according to the embodiments of the present invention;

FIG. 5 illustrates a flow chart of a user customized automated gear shifting system according to the embodiments of the present invention; and

FIG. 6 illustrates an exemplary joystick button for controlling derailleurs of a bicycle according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to those skilled in the relevant art and having possession of this disclosure, are to be considered within the scope of the invention claimed.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof The programming code may execute entirely on the user's computer, partly on the user's computer, as a stand-alone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks. As used herein, a “terminal” should be understood to be any one of a general purpose computer, as for example a personal computer or a laptop computer, a client computer configured for interaction with a server, a special purpose computer such as a server, or a smart phone, soft phone, tablet computer, personal digital assistant or any other machine adapted for executing programmable instructions in accordance with the description thereof set forth above.

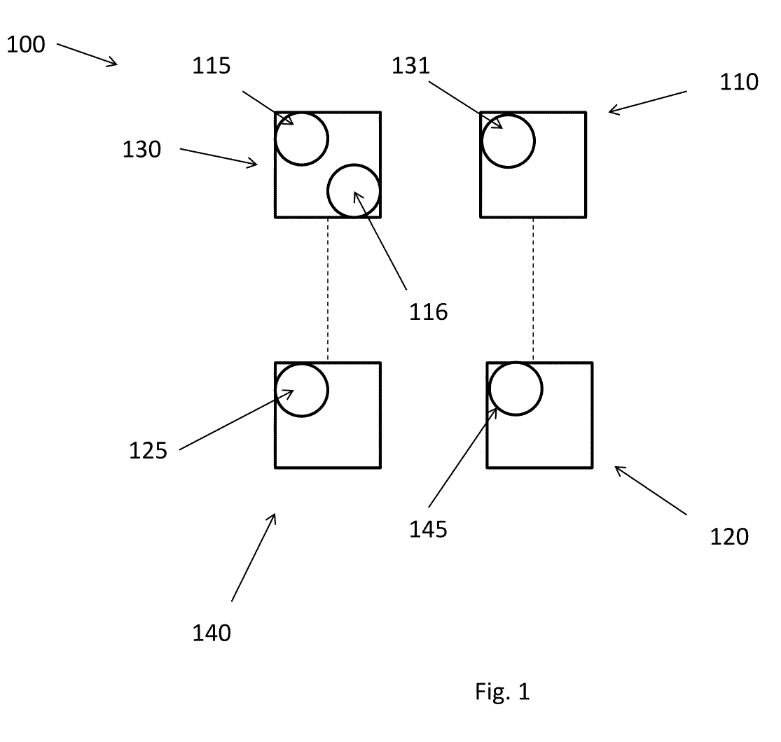

FIG. 1 shows a block diagram of wireless bicycle system 100 according to the embodiments of the present invention. The block diagram includes a brake light input 110, brake lights 120, turn signal input 130 and turn signals 140. While BLE technology is detailed below, any wireless technology can be used to facilitate the embodiments of the present invention.

In one embodiment, the brake light input 110 comprises a pair of brake levers with integral pressure switches 115 positioned to be actuated by said brake levers. When any tangible pressure is applied to the brake levers, the pressure switches 115 are actuated triggering a BLE transmitter 116 which sends a BLE wireless signal to a BLE receiver 125 in communication with the brake lights 120. In one embodiment, the brake lights 120 comprise BLE-equipped light emitting diodes (LEDs) positioned on the bicycle (e.g., seat) or a rider's equipment (e.g., helmet).

The quick-acting brake lights 120 reduce bicycle crashes by providing trailing vehicles notice that the bicycles ahead are braking This is particularly important in situations where there are closely drafting bicyclists. Professional and amateur bicycle riders draft to reduce wind resistance for the group. Bicycle crashes often occur when trailing riders do not recognize quickly enough that the bicycles in front are braking While a BLE wireless system is detailed herein, those skilled in the art will recognize that other wireless technologies may be used without departing from the spirit and scope of the embodiments of the present invention.

In one embodiment, the turn signal input 130 is a rocker switch mounted on the bicycle (e.g., handlebars or seat post). In one embodiment, depressing the rocker switch left or right triggers a BLE transmitter 131 transmitting a BLE wireless signal to a BLE receiver 145 in communication with the turn signals 140 causing the proper turn signal 140 to activate. The turn signals 140 may also flash in an emergency manner or act as running lights depending on the input. In one embodiment, activation of the turn signals 140 generates an audible tone such that the rider remembers to deactivate the turn signal once the turn has been completed. The audible tone may also be generated by a mobile device when integrated into the system as described in more detail below.

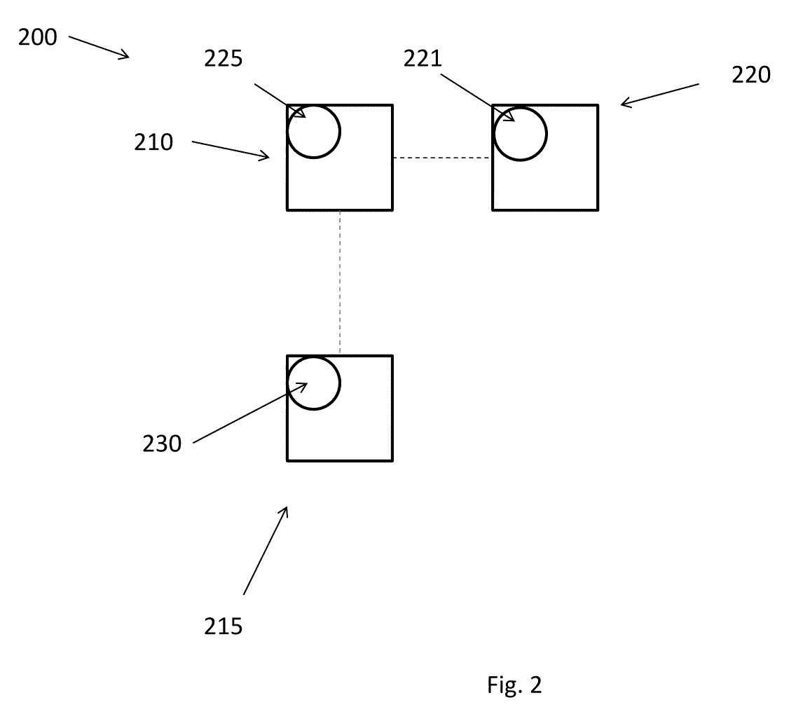

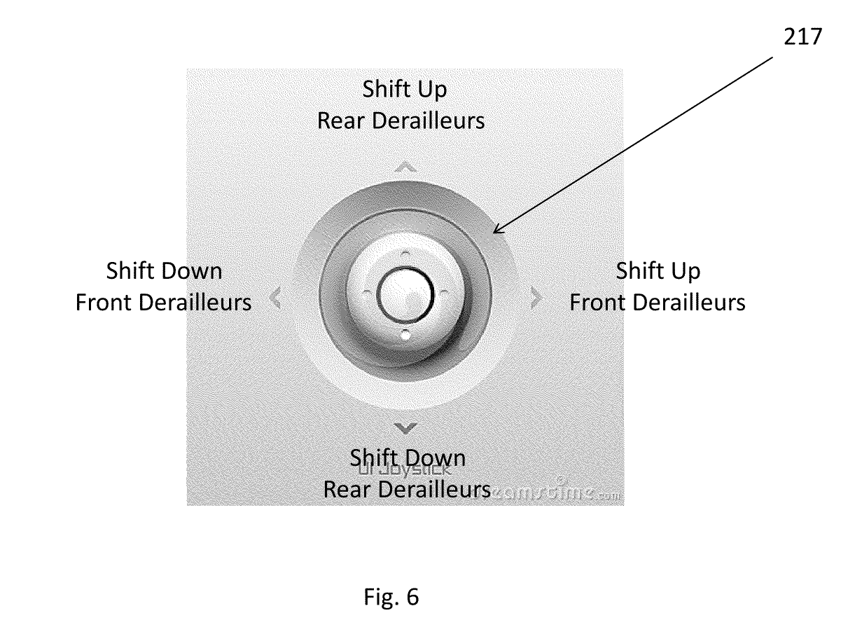

FIG. 2 shows a block diagram of wireless bicycle system 200 according to the embodiments of the present invention. The block diagram includes front electronic motor-driven derailleurs 210, rear electronic motor-driven derailleurs 215 and gear-shifting input 220. Shimano of Japan makes electronic motor-driven derailleurs (e.g., Shimano Ultegra Di2 RD-6770 Rear Derailleur) of the type suitable for the embodiments of the present invention. The embodiments of the present invention are suitable for use with derailleur gears, gears, sprockets and similar bicycle shifting mechanisms. In this embodiment, as shown in FIG. 6, the gear-shifting input is a BLE joystick button 217 wherein rocking the button right and left triggers a BLE transmitter 221 to transmit a signal to a BLE receiver 225 in communication with, and controlling, the front derailleurs and rocking the button forward and rearward transmits a signal to the BLE receiver 230 in communication with, and controlling, the rear derailleurs. Upon receipt of the signal, the BLE receivers 225, 230 act to instruct motors of the front derailleurs and rear derailleurs to shift accordingly. Other input devices, including a touchpad, toggle switch, individual buttons and the like, may be used to generate inputs.

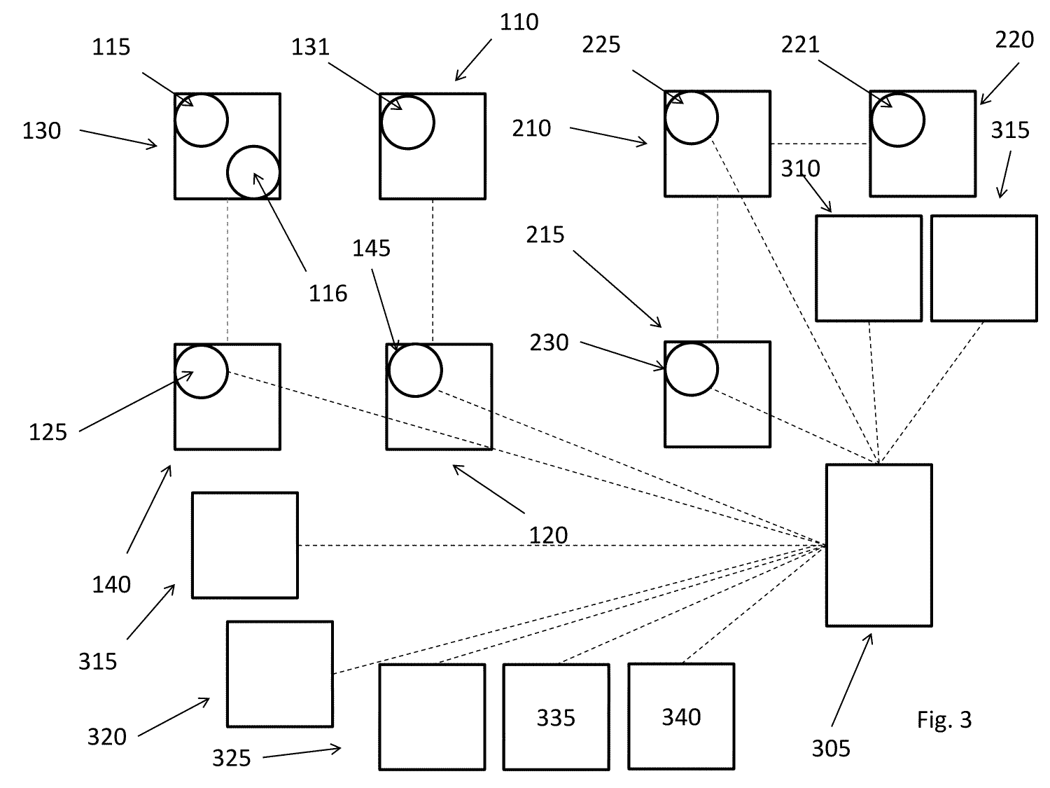

FIG. 3 shows a block diagram incorporating a wireless bicycle system 300 incorporating smartphone or tablet technology in combination with the wireless features described above. The wireless bicycle system 300 incorporates those components set forth relative to systems 100 and 200. As shown, a mobile device such as a smartphone or similar mobile device (e.g., tablet) 305 is incorporated to provide additional functionality.

In one embodiment, the mobile device 305 is used as an information center which collects and evaluates information transmitted by various sensors associated with the bicycle, environment and/or rider. Any computer (e.g., laptop, desktop, etc.) may be used in lieu of, or conjunction with, the mobile device 305. Indeed, the mobile device may be in communication with a computer or server to assist with information receipt and data analysis.

In one embodiment, a BLE equipped heart-rate monitor 310 and a BLE equipped crank position/cadence sensor 315 are monitored by the mobile device 300. In such an embodiment, software running on the mobile device 300 varies the rider's effort (i.e., heart rate) and crank cadence (i.e., revolutions per minute) by selecting the proper gearing (front and rear derailleur combinations) of the front and rear derailleurs 215, 220. Based on the need to shift, the software transmits a BLE signal to the BLE receivers 225, 230 of front and/or rear derailleurs 215, 220, respectively, shifting them accordingly via their motors. The software may also transmit BLE signals to the BLE receivers 145 of the turn signals 140 responsive to the GPS and/or accelerometer of the mobile device indicating a turn is occurring or may send a BLE signal to the BLE receiver 125 of the brakes 120 to the GPS and/or accelerometer of the mobile device indicating a stop is occurring.

The system may also utilize the automatic transmission functionality to aid in the efficiency of the rider and assist in his or her fitness training In one embodiment, additional sensors are incorporated into the system including a wind speed sensor 315, angle of attack sensor 320 and torque sensor 325 measured at the crankshaft. In one embodiment, the wind speed sensor 315 is a small wind speed indicator which gives the rider information about a head or tail wind such that the software application can take such information into account. Also, the angle of attack sensor 320 may be an accelerometer in the mobile device (e.g., iPhone®) allowing angle of attack information to be programed into the shifting routine. A GPS module and/or accelerometer in the mobile device may measure speed as another variable. The software application can be written to accept any number of variables associated with a rider's efforts, or the bicycle or the environment.

Responsive to the sensor readings, the software varies the rider's effort (heart rate) and pedal cadence (revolutions per minute) by selecting the proper gearing (front and rear derailleurs 215, 220). Because the front and rear derailleurs 215, 220 are controlled by BLE signals they can be controlled using BLE buttons 330 or other gear-shifting input or the BLE signal from the mobile device 300 (e.g., iPhone). In practice, the rider input control overrides the automated software instructions.

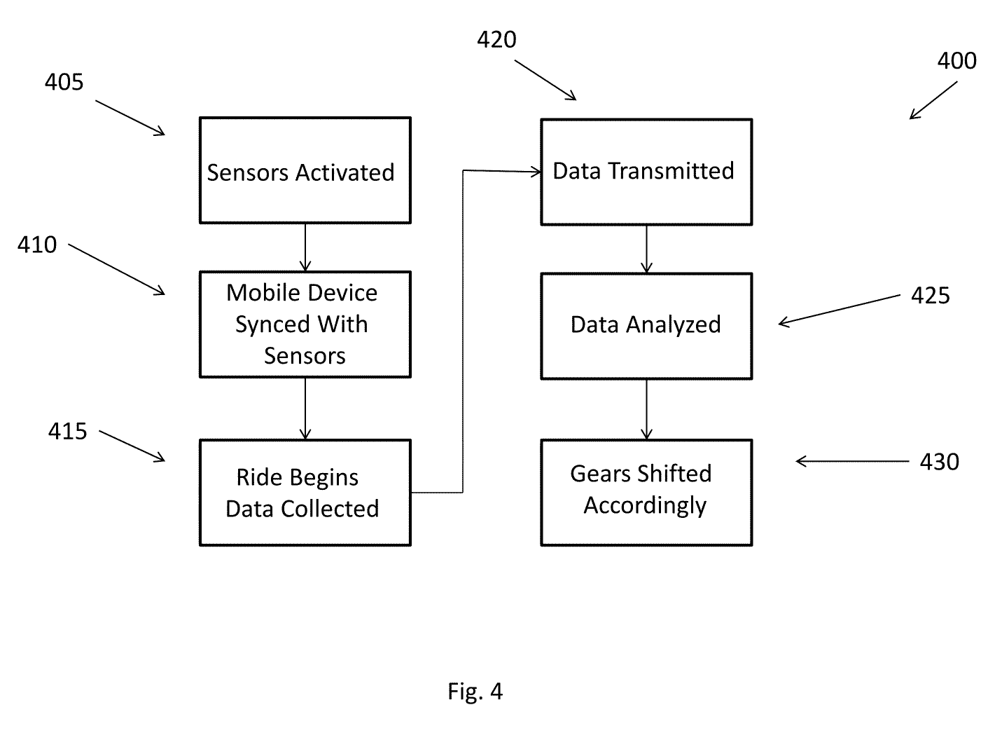

FIG. 4 shows a flow chart 400 for an automated system. At 405, bicycle, rider and/or environment sensors are activated. At 410, mobile device is synced with said sensors. At 415, a rider begins to ride and said sensors collect data. At 420, sensor-collected data begins being continuously transmitted to the mobile device 305 (or central server in communication therewith). At 425, the transmitted sensor-collected data is analyzed. At 430, depending on the analysis of the sensor-collected data, front and rear derailleurs may be automatically shifted up or down.

In one embodiment, a rider selects parameters, such as a desired cadence and heart rate, which the system operates under. The software (e.g., smartphone software application) then selects the gear based on those preselected parameters. Speed then becomes a function of the rider's effort as reflected by his or her heart rate and/or how fast or slow the rider desires to spin. The software application keeps the rider in a chosen zone by intelligent choice of gear. For example, the rider can get 30 mph with minimal effort downhill, but the rider might find themselves in Zone 3 (86% to 100% heart rate max) while crawling at 9 mph grinding at their lowest gear going up the hill. The software application utilizes information and recommendations regarding the best heart rate and cadence in a given situation. Ranges can be selected for the lowest and highest heart rate during a given ride. Elite riders tolerate more effort and pedal faster than intermediate riders, but with the embodiments of the present invention riders may select parameters and/or settings can be suggested for riders based on their riding experience and fitness level.

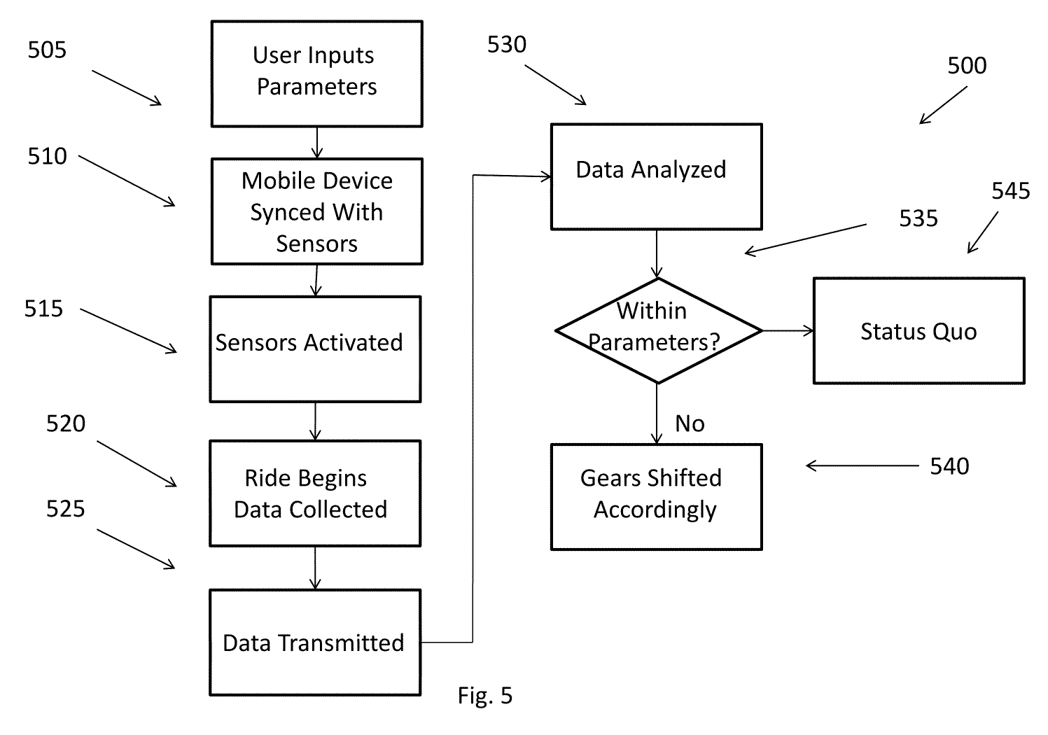

FIG. 5 shows a flow chart 500 for an automated system. At 505, a rider inputs desired parameters into system via mobile device interface or computer interface. At 510, bicycle, rider and/or environment sensors are activated. At 515, mobile device is synced with said sensors. At 520, a rider begins to ride and said sensors collect data. At 525, sensor-collected data begins being continuously transmitted to the mobile device 305 (or central server in communication therewith). At 530, the transmitted sensor-collected data is analyzed. At 535, it is determined if the data corresponds to the input parameters. If not, at 540, depending on the analysis of the sensor-collected data, front and rear derailleurs may be shifted up or down. If so, at 545, the status quo is maintained.

In one embodiment, a rider can analyze and evaluate a ride on a computer (e.g., iPad). By utilizing the mobile device for data logging, the rider can keep ride data for later analysis and evaluation. Multiple rides over the same course can be compared to see how fitness and skill has improved. Since the mobile device can store into SQL databases the result can be viewed on a wide range of platforms. All the collected data may be logged and coordinated with GPS to track an entire ride whereby subsequent rides can be compared to track fitness and skill improvements.

In one embodiment, the rider specifies the workout routine such that the mobile device selects songs from a digital music library having a corresponding cadence. Responsive to the cadence changing, the song selection changes automatically.

There are a number of fitness drills that can be accomplished using the embodiments of the present invention. For example, the cadence sensor 315 and heart-rate monitor 310 may be used to determine how the rider races and how the rider can improve.

In one embodiment, lights 335 or audible signal devices 340 can be used to notify the rider to speed up or slow down their cadence based on the variation in crank speed, selected cadence and/or heart-rate differences. For simple cruising, the rider might select a comfortable slow cadence and the mobile device application acts as a simple automatic transmission to maintain the leisurely cadence.

Although the invention has been described in detail with reference to several embodiments, additional variations and modifications exist within the scope and spirit of the invention as described and defined in the following claims.

We claim:

1. A bicycle comprising:
at least one of:
brake lights,
turn lights,
headlights, and
electronic motor-driven derailleurs;
an input device including a wireless transmitter, said input device positioned for operation by a rider of said bicycle; and
one or more wireless receivers configured to control said at least one of brake lights, turn lights, headlights and electronic motor-driven derailleurs responsive to inputs generated by said input device.

2. The bicycle of claim 1 wherein said wireless input device is a Bluetooth low energy device.

3. The bicycle of claim 1 wherein said one or more wireless receivers are Bluetooth low energy devices.

4. A system comprising:
a bicycle having at least one of brake lights, turn lights, headlights and electronic motor-driven derailleurs;
one or more wireless receivers configured to control said at least one of brake lights, turn lights, headlights and electronic motor-driven derailleurs; and
a mobile device software application configured to: (i) receive information related to said bicycle, environment of said bicycle and/or rider of said bicycle during a ride; and (ii) responsive to said information, cause wireless signals to be transmitted to said one or more wireless receivers to automatically control said at least one of brake lights, turn lights, headlights and electronic motor-driven derailleurs.

5. The system of claim 4 further comprising one or more sensors to monitor one or more of the following: heart rate, wind speed, angle of attack, heart rate, cadence, crank speed, crank torque and speed.

6. The system of claim 4 wherein said wireless input device is a Bluetooth low energy device.

7. The system of claim 4 wherein said one or more wireless receivers are Bluetooth low energy devices.

8. The system of claim 4 further comprising an accelerometer for determine bicycle orientation.

9. A system comprising:
a bicycle having electronic motor-driven derailleurs;
one or more wireless receivers configured to control electronic motor-driven derailleurs; and
a mobile device software application configured to: (i) receive user-provided parameters related to a bicycle ride; (ii) receive information related to said bicycle, environment of said bicycle and/or rider of said bicycle during a ride; (iii) determine if said information corresponds to said parameters; and (iv) if said information does not correspond to said parameters, cause wireless signals to be transmitted to said one or more wireless receivers to automatically control said electronic motor-driven derailleurs.

10. The system of claim 9 further comprising one or more sensors to monitor one or more of the following: heart rate, wind speed, angle of attack, heart rate, cadence, crank speed, crank torque and speed.

11. The system of claim 9 wherein said wireless input device is a Bluetooth low energy device.

12. The bicycle of claim 9 wherein said one or more wireless receivers are Bluetooth low energy devices.

13. The system of claim 9 further comprising an accelerometer for determine bicycle orientation.

14. A method comprising:
(i) receiving user-provided parameters related to a bicycle ride;
(ii) receiving information related to said bicycle, environment of said bicycle and/or rider of said bicycle during a ride;
(iii) determining if said information corresponds to said parameters; and
(iv) if said information does not correspond to said parameters, causing wireless signals to be transmitted to said one or more wireless receivers to automatically control said electronic motor-driven derailleurs.

15. The method of claim 14 wherein said parameters are one or more of the following: heart rate, wind speed, angle of attack, heart rate, cadence, crank speed, crank torque and speed.

16. The method of claim 14 further comprising determining bicycle orientation via an accelerometer.
